(19) United States
(12) Patent Application Publication
(10) Pub. No.: US 2021/0020970 A1
(43) Pub. Date: Jan. 21, 2021

(54) FUEL CELL SYSTEM AND FUEL CELL VEHICLE

(71) Applicant: HONDA MOTOR CO., LTD., Tokyo (JP)

(72) Inventors: Ryoichi Yoshitomi, Wako-shi (JP); Manabu Mitani, Wako-shi (JP)

(21) Appl. No.: 16/928,046

(22) Filed: Jul. 14, 2020

(30) Foreign Application Priority Data
Jul. 16, 2019 (JP) 2019-131134

(51) Int. Cl. H01M 8/04082; H01M 8/2475; B60L 50/72

(52) U.S. Cl. CPC H01M 8/04201; H01M 2250/20; B60L 50/72; H01M 8/2475

(57) ABSTRACT

A fuel cell vehicle is equipped with a fuel cell system including a stack case, an auxiliary device case, and a fuel gas pipe. The stack case contains a cell stack body of power generation cells. The auxiliary device case is provided adjacent to one end of the stack case, and contains a fuel cell auxiliary device. The fuel gas pipe is connected to the auxiliary device case, and a fuel gas is supplied into the fuel cell auxiliary device through the fuel gas pipe. The fuel cell system includes a cutout formed by cutting out part of the auxiliary device case, and the fuel gas pipe is disposed in the fuel cell system so as to pass nearby the cutout.

### CROSS-REFERENCE TO RELATED APPLICATION

This application is based upon and claims the benefit of priority from Japanese Patent Application No. 2019-131134 filed on Jul. 16, 2019, the contents of which are incorporated herein by reference.

### BACKGROUND OF THE INVENTION

### Field of the Invention

The present invention relates to a stack case containing a stack body including a plurality of power generation cells stacked together, and an auxiliary device case containing a fuel cell auxiliary device.

### Description of the Related Art

For example, a solid polymer fuel cell includes a membrane electrode assembly (MEA). The membrane electrode assembly includes an electrolyte membrane, an anode on one surface of the electrolyte membrane, and a cathode provided on the other surface of the electrolyte membrane. The electrolyte membrane is a polymer ion exchange membrane. The membrane electrode assembly is sandwiched between separators to form a power generation cell. A plurality of the power generation cells are stacked together to form a stack body.

A terminal plate, an insulating plate, an end plate, etc. are stacked on the stack body to obtain a fuel cell stack. The fuel cell stack is stored in a stack case, and an auxiliary device case containing a fuel cell auxiliary device such as an injector of a fuel gas is provided adjacent to the stack case, whereby the fuel cell system is structured. In use, the fuel cell system of this type is mounted in a front box of a fuel cell vehicle.

In this regard, such a fuel cell system used in a fuel cell vehicle is required to have structure where leakage of the fuel gas such as hydrogen does not occur even when an impact load is applied to the fuel cell system due to collision of the fuel cell vehicle. Japanese Patent No. 3671864 discloses structure where a fuel gas pipe inside an auxiliary device case is disposed adjacent to the stack having high rigidity to thereby protect the fuel gas pipe.

### SUMMARY OF THE INVENTION

However, though the fuel cell system of Japanese Patent No. 3671864 can achieve protection of the hydrogen pipes inside the auxiliary device case, there is no disclosure regarding structure of protecting the hydrogen pipe extending from the auxiliary device case up to the hydrogen tank.

An object of the present invention is to provide a fuel cell system and a fuel cell vehicle in which it is possible to protect a hydrogen pipe connected to an auxiliary device case even if an impact load is applied.

According to an aspect of the present invention, a fuel cell system is provided. The fuel cell system includes a stack case containing therein a stack body of power generation cells, an auxiliary device case provided adjacent to one end of the stack case and containing therein a fuel cell auxiliary device, and a fuel gas pipe through which a fuel gas is supplied into the fuel cell auxiliary device. The auxiliary device case is provided with a cutout that is formed by cutting out an upper end corner between an upper end of the auxiliary device case and one end surface of the auxiliary device case that is spaced from the stack case. The cutout is inclined so as to become higher in level from the one end surface toward the stack case, and the fuel gas pipe is disposed to pass nearby the cutout.

Another aspect of the present invention relates to a fuel cell vehicle equipped with the above fuel cell system.

In the fuel cell system and the fuel cell vehicle according to the above aspect, even if the impact load is applied, it is possible to protect the hydrogen pipe by the space created by the cutout of the auxiliary device case.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a view schematically showing structure of a fuel cell vehicle equipped with a fuel cell system according to an embodiment of the present invention;

FIG. 2 is a perspective view showing outer appearance of the fuel cell system in FIG. 1;

FIG. 3 is a view showing a layout where the fuel cell system in FIG. 1 is mounted in a fuel cell vehicle;

FIG. 4 is a view showing the fuel cell system of FIG. 3 as viewed from the front side;

FIG. 5 is a view showing operation of the fuel cell system in FIG. 1; and

FIG. 6 is a view showing operation of a fuel cell system according to a comparative example.

### DESCRIPTION OF THE PREFERRED EMBODIMENTS

Hereinafter, a preferred embodiment of a fuel cell system and a fuel cell vehicle according to the present invention will be described in detail with reference to the accompanying drawings.

Directions in the drawings will be mentioned based on the fuel cell vehicle 10. More specifically, the left side of the driver will be denoted by an arrow “L”, the right side of the driver will be denoted by an arrow “R”, the front side of the driver will be denoted by an arrow “Fr”, the rear side of the driver will be denoted by “Rr”, the upper side of the driver will be denoted by “U”, and the lower side of the driver will be denoted by “D”.

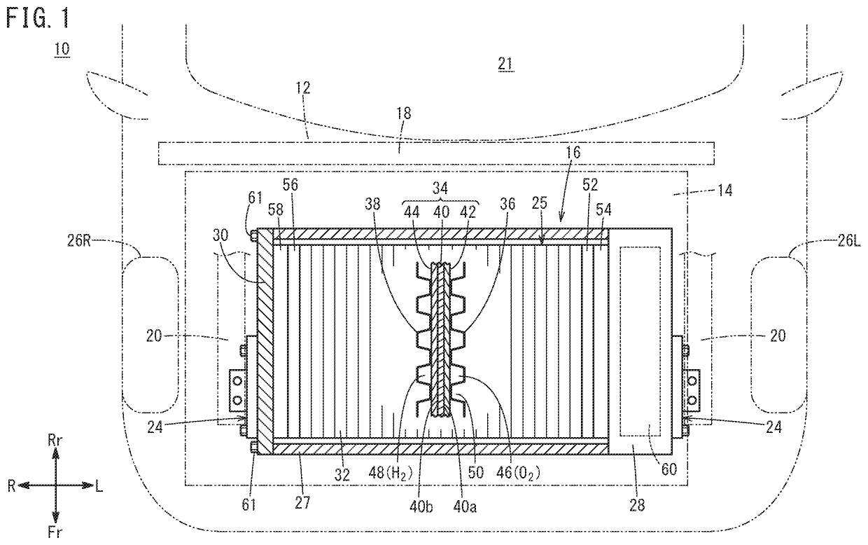

As shown in FIG. 1, the fuel cell vehicle 10 according to the embodiment is, for example, a fuel cell electric automobile. The fuel cell vehicle 10 includes a front box 14 (motor room) formed on the front side of a dashboard 12, a fuel cell system 16 arranged inside the front box 14, and brackets 24 for fixing the fuel cell system 16 to mounting members 20 (vehicle body frame). A pair of the mounting members 20 are provided on the right side and the left side of the vehicle (fuel cell vehicle 10), respectively, and extend in the front/rear direction (front and rear direction). The fuel cell system 16 is fixed to the mounting members 20 through the brackets 24, at an end plate 30 and an auxiliary device case 28 described later. The front box 14 is provided between left and right front wheels 26L, 26R. In addition to the fuel cell system 16, component parts such as a vehicle travel motor (not shown) are provided in the front box 14.

The fuel cell system 16 includes a cell stack body 25, a stack case 27, the auxiliary device case 28, and the end plate 30. The cell stack body 25 is formed by stacking a plurality of power generation cells 32 together in one direction (vehicle width direction, left/right direction). The power generation cell 32 includes a membrane electrode assembly 34, and a pair of separators 36, 38 sandwiching the membrane electrode assembly 34 from both sides.

For example, the membrane electrode assembly 34 includes a solid polymer electrolyte membrane 40, a cathode 42 provided on one surface 40a of the solid polymer electrolyte membrane 40, and an anode 44 provided on the other surface 40b of the solid polymer electrolyte membrane 40. The solid polymer electrolyte membrane 40 is a thin membrane of perfluorosulfonic acid containing water. A fluorine based electrolyte may be used as the electrolyte membrane 40. Alternatively, an HC (hydrocarbon) based electrolyte may be used as the electrolyte membrane 40.

Each of the separators 36, 38 is formed by press forming a metal thin plate to have a corrugated shape in cross section and a wavy shape on the surface. For example, the metal plate is a steel plate, a stainless steel plate, an aluminum plate, a plated steel plate, or a metal plate having an anti-corrosive surface by surface treatment. The separators 36, 38 may be made of carbon material.

An oxygen-containing gas flow field 46 as a passage of an oxygen-containing gas (e.g., the air) is formed on a surface of the separator 36 facing the cathode 42. A fuel gas flow field 48 as a passage of a fuel gas (e.g., a hydrogen gas) is formed on a surface of the separator 38 facing the anode 44. A coolant flow field 50 as a passage of a coolant is formed between the adjacent separators 36, 38.

The oxygen-containing gas is supplied to the cathode 42. The fuel gas is supplied to the anode 44. The power generation cell 32 performs power generation by electrochemical reaction of the oxygen-containing gas supplied to the cathode 42 and the fuel gas supplied to the anode 44.

At one end of the cell stack body 25 in the stacking direction (the end in a direction indicated by an arrow L), a first terminal plate 52 is provided. A first insulating plate 54 is provided outside the first terminal plate 52. At the other end of the cell stack body 25 in the stacking direction (the end in the direction indicated by the arrow R), a second terminal plate 56 is provided. A second insulating plate 58 is provided outside the second terminal plate 56.

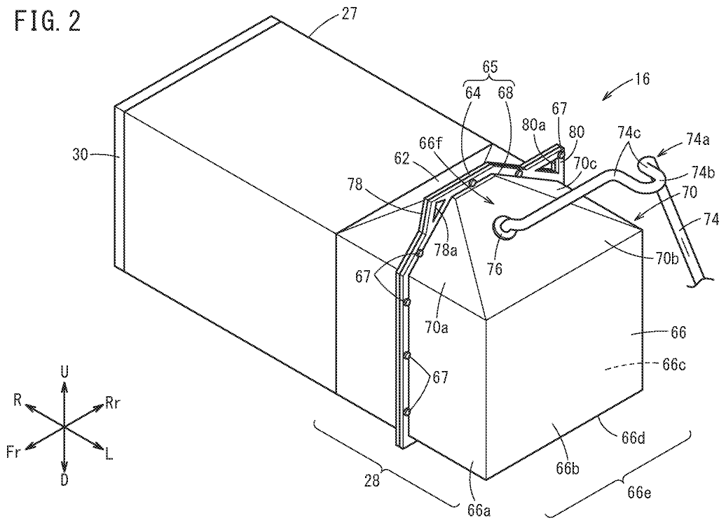

As shown in FIGS. 1 and 2, the stack case 27 has a quadrangular cylindrical shape extending in the vehicle width direction. The stack case 27 covers the cell stack body 25 from the upper/lower directions and the front/rear directions. In FIG. 1, the auxiliary device case 28 is a protection case for protecting a fuel cell auxiliary device 60, and is fixed to one end of the stack case 27 (the end in a direction indicated by an arrow L). The auxiliary device case 28 contains therein, as the fuel cell auxiliary device 60, a fuel gas system device and an oxygen-containing gas system device.

As shown in FIGS. 1 and 2, the end plate 30 is fixed to the other end of the stack case 27 (the end in the direction indicated by the arrow R) in a manner to close an opening at the other end of the stack case 27. The end plate 30 is a rectangular metal plate, and is fastened to the other end of the stack case 27 using a plurality of bolts 61. The end plate 30 applies the tightening load in the stacking direction to the cell stack body 25. Though not shown, a seal member made of elastic material is provided between the stack case 27 and the end plate 30 so as to extend over the entire periphery of the joint portion of the stack case 27 and the end plate 30.

As shown ion FIG. 2, the auxiliary device case 28 includes a box shaped first case member 62 opened at one end (the end in the direction indicated by the arrow L), and a box shaped second case member 66 opened at the other end (the end in the direction indicated by the arrow R). The second case member 66 is disposed in a manner to close an opening of the first case member 62, and forms the auxiliary device case 28. A flange 64 is formed on a peripheral edge portion at one end of the first case member 62 in a manner to protrude outward. Further, a flange 68 is formed on a peripheral edge portion at the other end of the second case member 66 in a manner to protrude outward. The flange 64 of the first case member 62 and the flange 68 of the second case member 66 are fastened together by a plurality of bolts 67 to thereby join the first case member 62 and the second case member 66 together.

The other end of the first case member 62 (the end in the direction indicated by an arrow R) is joined to the stack case 27 in a manner to close an opening at one end of the stack case 27, and the first case member 62 is fastened to the one end of the stack case 27 using bolts. The first case member 62 also serves as a function of the end plate of the stack case 27. Therefore, the first case member 62 contacts the first insulating plate 54 (see FIG. 1) to apply a tightening load in the stacking direction to the cell stack body 25, between the first case member 62 and the end plate 30.

The second case member 66 includes a body part 66e including a front surface 66a, one end surface 66b, a rear surface 66c, and a bottom surface 66d, and an upper end 66f formed at an upper end side of the body part 66e. The front surface 66a is a surface disposed on the front side of the vehicle body. The rear surface 66c is a surface disposed on the rear side of the vehicle body. The front surface 66a and the rear surface 66c are formed as surfaces substantially perpendicular to the front/rear direction (directions indicated by the arrows Fr, Rr). The bottom surface 66d is provided between the lower end of the front surface 66a and the lower end of the rear surface 66c to cover the bottom of the second case member 66. The one end surface 66b is a surface which covers one end of the second case member 66 (in the direction indicated by the arrow L) and formed as a surface substantially perpendicular to the vehicle width direction (directions indicated by the arrows R and L).

Further, an expansion 70 is formed at the upper end 66f of the second case member 66. The expansion 70 protrudes upward beyond upper ends of the front surface 66a, the one end surface 66b, and the rear surface 66c. The expansion 70 of the second case member 66 includes a front surface side upper end surface 70a extending from the upper end of the front surface 66a, a cutout 70b connected to an upper end of the one end surface 66b, and a rear surface side upper end surface 70c extending from an upper end of the rear surface 66c.

The front surface side upper end surface 70a comprises an inclined surface oriented toward the front side. The front surface side upper end surface 70a is inclined in a manner to protrude upward gradually toward the central part in the front/rear direction of the second case member 66. The rear surface side upper end surface 70c comprises an inclined surface oriented toward the rear side. The rear surface side upper end surface 70c is inclined in a manner to protrude upward gradually toward the central part in the front/rear direction of the second case member 66.

The cutout 70b extends in parallel to the front/rear direction of the vehicle which is a direction in which the impact load is expected to be applied, and the cutout 70b is formed by cutting out an upper end corner of the auxiliary device case 28 at an angle. That is, the cutout 70b is inclined from the vehicle width direction (directions indicated by the arrows R, L) and the upper/lower direction (directions indicated by the arrows U, D), and in a manner to protrude upward gradually from the upper end of the one end surface 66b toward the flange 68 of the second case member 66. Further, the cutout 70b may be formed by cutting the one end surface 66b of the auxiliary device case 28 from the one end side in a V-shape.

The expansion 70 is formed by the front surface side upper end surface 70a and the rear surface side upper end surface 70c in a manner that the central part of the second case member 66 in the front/rear direction is highest, as viewed from the side. Further, the expansion 70 is formed by the cutout 70b in a manner that the other end of the expansion 70 (the second case member 66) where the flange 68 is formed is highest, as viewed from the front.

The flange 68 of the second case member 66 is formed so as to protrude outward from the other ends of the front surface 66a, the bottom surface 66d, the rear surface 66c, and the expansion 70. The flange 64 of the first case member 62 has substantially the same outer shape as the flange 68 of the second case member 66. In a state where the flange 64 and the flange 68 are in surface-to-surface contact with each other, the flange 64 and the flange 68 are fastened together using bolts 67 to thereby form rib structure 65. The rib structure 65 protrudes from the front surface 66a, the rear surface 66c, the upper end 66f, and the bottom surface 66d of the auxiliary device case 28. In the auxiliary device case 28, the rib structure 65 is a portion having high rigidity in the front/rear direction.

The rib structure 65 forms reinforcement structure which suppresses deformation and damage when the impact load is applied in the front/rear direction.

In the auxiliary device case 28 of the embodiment of the present invention, the rib structure 65 additionally includes a first protrusion 78 protruding outward (upward and frontward) of the front surface side upper end surface 70a of the expansion 70, and a second protrusion 80 protruding outward (upward and rearward) significantly from the rear surface side upper end surface 70c. When the fuel cell system 16 is displaced toward the dashboard 12 (see FIG. 1) by application of the impact load, the second protrusion 80 is brought into contact with the dashboard 12 to thereby create a space between the auxiliary device case 28 and the dashboard 12. The dimensions of the second protrusion 80 are appropriately determined such that the space sufficient to protect a fuel gas pipe 74 is formed between the auxiliary device case 28 and the dashboard 12.

Further, the first protrusion 78 and the second protrusion 80 have respective holes 78a, 80a penetrating through the rib structure 65 made up of the flange 64 and the flange 68 in the thickness direction, in order to make it easier to perform suspending (hanging) operation of the fuel cell system 16 at the time of performing maintenance and repair or the like. The holes 78a, 80a have sizes which enable suspension hooks to be attached to the holes 78a, 80a. Thus, the first protrusion 78 having the hole 78a and the second protrusion 80 having the hole 80a form suspension structure of the fuel cell system 16.

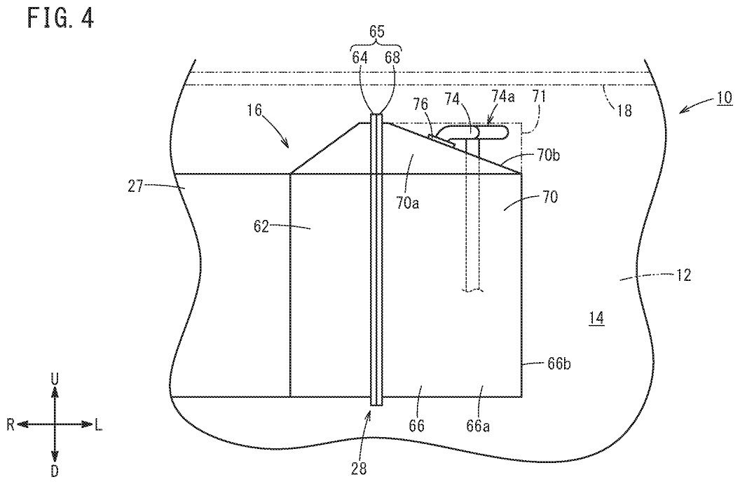

A connection port 76 is provided in the cutout 70b of the expansion 70. The fuel gas pipe 74 is connected to the connection port 76. The fuel gas is supplied through the fuel gas pipe 74 to the fuel cell auxiliary device 60 (see FIG. 1) such as an injector. The fuel gas pipe 74 is routed toward the rear side of the auxiliary device case 28 along the cutout 70b. Further, the fuel gas pipe 74 has a serpentine part 74a extending in a serpentine pattern in the vehicle width direction. The serpentine part 74a includes a turn portion (U-turn portion) 74b which turns back so as to protrude toward the left side in the vehicle width direction as viewed from above, and a bent portion 74c provided at both ends of the turn portion 74b. It should be noted that the number of bent portions of the serpentine part 74a is not limited to three. A plurality of turn portions 74b may be provided as necessary. The serpentine part 74a is disposed outside the surface extending rearward from the cutout 70b (i.e., outside in the direction indicated by the arrow L), and the serpentine part 74a is disposed at such a position that, even if the fuel cell system 16 is displaced rearward by application of the impact load, the serpentine part is not sandwiched between the dashboard 12 and the fuel cell system 16. A portion of the fuel gas pipe 74 rearward of the bent portion 74c extends toward a lower position of the vehicle as shown in the drawing. The fuel gas pipe 74 passes along a lower side of a vehicle compartment 21, and is connected to the fuel gas tank (e.g., hydrogen tank) provided on the rear side of the vehicle. As shown in FIG. 4, the fuel gas pipe 74 is disposed adjacent to the rear surface 66c of the auxiliary device case 28, at a position where the fuel gas pipe 74 does not protrude beyond the auxiliary device case 28 in the vehicle width direction.

The fuel gas pipe 74 is made of flexible resin material such as rubber and/or various elastomers, or plastically deformable metal material such as stainless steel, aluminum or its alloy, copper or copper alloy. The fuel gas pipe 74 is configured not to be broken or fractured by absorbing deformation of the pipe by the serpentine part 74a even if displacement of the fuel cell system 16 occurs.

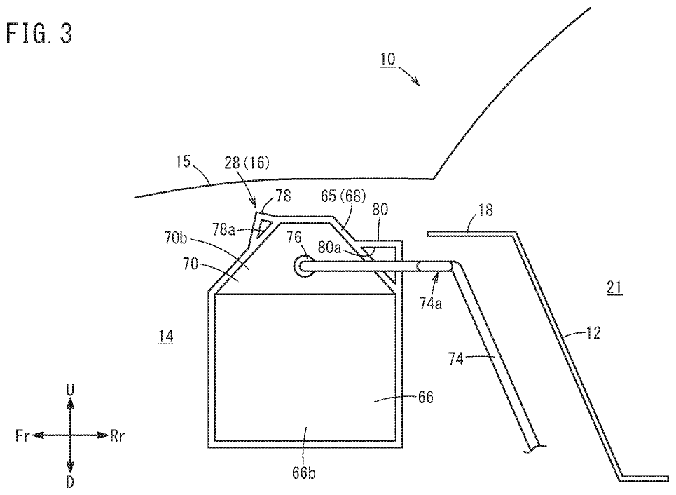

As shown in FIG. 3, the fuel cell system 16 is disposed in the front box 14 surrounded by the bonnet 15 and the dashboard 12 of the fuel cell vehicle 10. At this time, the expansion 70 of the auxiliary device case 28 is disposed at a position facing a dash upper 18 where an upper end of the dashboard 12 is bent toward the front side of the vehicle body.

The fuel gas pipe 74 extends along the cutout 70b of the expansion 70, toward a position adjacent to the dashboard 12 on the rear side, and routed toward a lower side of the dashboard 12. As shown in FIG. 4, the rib structure 65 having the second protrusion 80 (see FIG. 3) forms a space 71 adjacent to the cutout 70b of the auxiliary device case 28. In the space 71, contact with peripheral members such as the dashboard 12 and the dash upper 18 does not occur. The fuel gas pipe 74 is routed so as to extend in the space 71.

The fuel cell system 16 according to the embodiment of the present invention has the structure as described above. Hereinafter, operation of the fuel cell system 16 will be described.

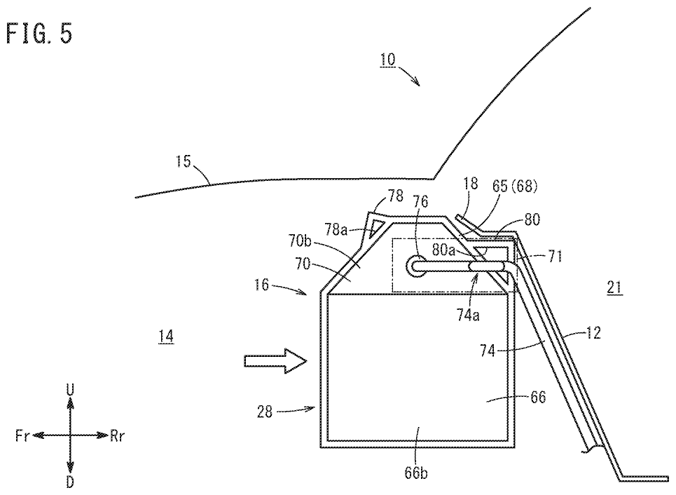

As shown in FIG. 5, an impact load is applied from the front side (in the direction indicated by the arrow Fr) to the rear side (in the direction indicated by the arrow Rr) of the fuel cell vehicle 10, and as a result, the fuel cell system 16 is displaced toward the rear side (in the direction indicated by the arrow Rr) of the fuel cell system 16. When the fuel cell system 16 is displaced, the second protrusion 80 provided on the rib structure 65 of the auxiliary device case 28 (second case member 66) is brought into contact with the dashboard 12, and the second protrusion 80 pushes up the dash upper 18, and the second protrusion 80 is displaced backward further.

Owing to the above configuration, the safe space 71 where there is no interference with the vehicle body structure such as the dashboard 12 is created adjacent to the cutout 70b of the second case member 66. Since the fuel gas pipe 74 is provided adjacent to the cutout 70b, the fuel gas pipe 74 is accommodated in this space 71. Therefore, even in the case where the impact load is applied and the fuel cell system 16 is then displaced, it is possible to protect the fuel gas pipe 74.

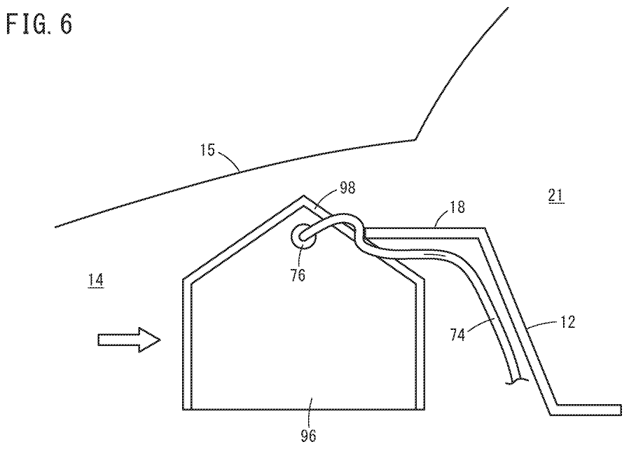

On the other hand, as shown in FIG. 6, in a fuel cell stack 96 according to a comparative example, the auxiliary device case 28 does not have the cutout 70b, and rib structure 98 does not have the protrusion. In the fuel cell stack 96, in the case where the fuel cell stack 96 is displaced backward by application of the impact load, the safe space 71 cannot be created between the fuel cell stack 96 and the dashboard 12. Under the circumstances, the fuel gas pipe 74 may interfere with component parts of the vehicle body such as the dashboard 12, and a large load may be applied to the fuel gas pipe 74.

In contrast, in the fuel cell system 16 according to the embodiment of the present invention, it is possible to accommodate and protect the fuel gas pipe 74 in the safe space 71 where there is no interference with the vehicle body structure such as the dashboard 12, at a position adjacent to the cutout 70b of the second case member 66.

The fuel cell system 16 and the fuel cell vehicle 10 according to the embodiment of the present invention offer the following advantages.

The fuel cell system 16 according to the embodiment of the present invention includes the stack case 27 containing therein the stack body (cell stack body 25) of power generation cells 32, the auxiliary device case 28 provided adjacent to one end of the stack case 27 and containing therein the fuel cell auxiliary device 60, and the fuel gas pipe 74 through which the fuel gas is supplied into the fuel cell auxiliary device 60. The auxiliary device case 28 is provided with the cutout 70b that is formed by cutting out the upper end corner between the upper end 66f of the auxiliary device case 28 and one end surface 66b of the auxiliary device case that is spaced from the stack case 27. The cutout 70b is inclined so as to become higher in level from the one end surface 66b toward the stack case 27. The fuel gas pipe 74 is disposed to pass nearby a position adjacent to the cutout 70b. In the structure, the safe space 71 in which interference with the vehicle body structure of the dashboard 12, etc. does not occur is created adjacent to the cutout 70b, and it is possible to accommodate and protect the fuel gas pipe 74 in the space 71. Further, even in the case where the impact load is applied to the fuel cell system 16 and the fuel cell system 16 is thereby displaced toward the rear side, it is possible to create the safe space 71 where there is no interference with the vehicle body structure such as the dashboard 12, adjacent to the cutout 70b.

In the fuel cell system 16, the connection port 76 of the fuel gas pipe 74 may be provided in the cutout 70b. With the structure, it is possible to protect the fuel gas pipe 74 together with the connection port 76 in the safe space 71.

In the fuel cell system 16, the auxiliary device case 28 may include the first case member 62 and the second case member 66. One end of the first case member 62 is joined to the stack case 27, and the other end thereof has the opening. The second case member 66 faces the first case member 62, and is attached to the first case member 62 in a manner to cover the opening. The cutout 70b may be provided in the second case member 66. In this manner, by providing the cutout 70b in the second case member 66 remote from the stack case 27, it is possible to route the fuel gas pipe 74 at a position which is not sandwiched between the fuel cell system 16 and the vehicle body structure such as the dashboard 12 advantageously.

In the fuel cell system 16, the first case member 62 and the second case member 66 may be joined together through the flanges 64, 68, and the second protrusion 80 protruding outward may be formed on the rear surface side upper end surface 70c of the auxiliary device case 28. By adopting the structure, when the fuel cell system 16 is displaced toward the rear side by application of the impact load, the second protrusion 80 is brought into contact with the vehicle body structure such as the dashboard 12, and it is possible to create the safe space 71 where there is no interference with the vehicle body structure, adjacent to the cutout 70b.

In the fuel cell system 16, the second protrusion 80 of the flange 64, 68 may be provided with suspension structure having a hole 80a penetrating through the flanges 64, 68 in the thickness direction. In the structure, it becomes unnecessary to provide the suspension member additionally, and simplify the structure of the auxiliary device case 28.

In the fuel cell system 16, the fuel gas pipe 74 may extend from the connection port 76 toward the rear surface of the auxiliary device case 28, and may include the serpentine part 74a bent toward the lateral side.

The fuel cell vehicle 10 according to the embodiment of the present invention is equipped with the above described fuel cell system 16. In the structure, even if the impact load is applied, it is possible to protect the fuel gas pipe 74 advantageously.

The fuel cell vehicle 10 according to the embodiment of the present invention may include the front box 14, the vehicle compartment 21 formed on the rear side of the front box 14, and the dashboard 12 separating the front box 14 and the vehicle compartment 21, and the fuel cell system 16 may be mounted in the front box 14 in a manner that the auxiliary device case 28 and the stack case 27 are arranged in the vehicle width direction, the fuel gas pipe 74 may extend along the cutout 70b in the front/rear direction toward a position adjacent to the dashboard 12, and the fuel gas pipe 74 may include the serpentine part 74a bent in the vehicle width direction. With the structure, even if the impact load is applied, it is possible to protect the fuel gas pipe 74 advantageously.

In the fuel cell vehicle 10, the dash upper 18 is provided at the upper end of the dashboard 12. The dash upper 18 is bent and extends toward the front side. The auxiliary device case 28 includes the first case member 62 and the second case member 66. One end of the first case member 62 is joined to the stack case 27, and the other end thereof has an opening. The second case member 66 faces the first case member 62, and is attached to the first case member 62 in a manner to cover the opening. When the impact load is applied, the flanges 64, 68 provided at the joint portion of the first case member 62 and the second case member 66 push up the dash upper 18 to thereby form the space 71 accommodating the fuel gas pipe 74, at a position between the cutout 70b and the dashboard 12. In the structure, it is possible to protect the fuel gas pipe 74.

Although the present invention has been described in connection with the preferred embodiment, the present invention is not limited to this embodiment. It is a matter of course that various modifications may be made without departing from the gist of the present invention.

What is claimed is:

1. A fuel cell system comprising:
a stack case containing therein a stack body of power generation cells;
an auxiliary device case provided adjacent to one end of the stack case, the auxiliary device case containing therein a fuel cell auxiliary device; and
a fuel gas pipe through which a fuel gas is supplied into the fuel cell auxiliary device,
wherein the auxiliary device case is provided with a cutout that is formed by cutting out an upper end corner between an upper end of the auxiliary device case and one end surface of the auxiliary device case that is spaced from the stack case;
the cutout is inclined so as to become higher in level from the one end surface toward the stack case; and
the fuel gas pipe is disposed to pass nearby the cutout.

2. The fuel cell system according to claim 1, wherein a connection port of the fuel gas pipe is provided in the cutout.

3. The fuel cell system according to claim 2, wherein the auxiliary device case includes:
a first case member, one end of the first case member being joined to the stack case, another end of the first case member having an opening; and
a second case member facing the first case member, and attached to the first case member in a manner to cover the opening,
and wherein the cutout is provided in the second case member.

4. The fuel cell system according to claim 3, wherein the first case member and the second case member are joined together through a flange; and
a protrusion protruding outward is formed on a rear surface side upper end surface of the auxiliary device case.

5. The fuel cell system according to claim 4, wherein the protrusion of the flange is provided with suspension structure having a hole penetrating through the flange in a thickness direction thereof.

6. The fuel cell system according to claim 2, wherein the fuel gas pipe extends from the connection port toward a rear surface of the auxiliary device case, and includes a serpentine part bent toward a lateral side.

7. A fuel cell vehicle equipped with a fuel cell system, the fuel cell system comprising:
a stack case containing therein a stack body of power generation cells;
an auxiliary device case provided adjacent to one end of the stack case, the auxiliary device case containing therein a fuel cell auxiliary device; and
a fuel gas pipe through which a fuel gas is supplied into the fuel cell auxiliary device,
wherein the auxiliary device case is provided with a cutout that is formed by cutting out an upper end corner between an upper end of the auxiliary device case and one end surface of the auxiliary device case that is spaced from the stack case;
the cutout is inclined so as to become higher in level from the one end surface toward the stack case; and
the fuel gas pipe is disposed to pass nearby the cutout.

8. The fuel cell vehicle according to claim 7, further comprising a front box, a vehicle compartment formed on a rear side of the front box, and a dashboard separating the front box and the vehicle compartment,
wherein the fuel cell system is mounted in the front box in a manner that the auxiliary device case and the stack case are arranged in a vehicle width direction, and the fuel gas pipe extends along the cutout in a front and rear direction toward a position adjacent to the dashboard; and
the fuel gas pipe includes a serpentine part bent in the vehicle width direction.
